(19) United States
(12) Patent Application Publication
(10) Pub. No.: US 2024/0226806 A9
(43) Pub. Date: Jul. 11, 2024

(54) ELECTROCHEMICAL HYDROGEN PUMP

(71) Applicant: Edwards Vacuum LLC, Sanborn, NY (US)

(72) Inventor: Zachary William Dunbar, Sanborn, NY (US)

(21) Appl. No.: 18/546,204

(22) PCT Filed: Jan. 31, 2022
(86) PCT No.: PCT/IB2022/050814

§ 371 Date: Aug. 11, 2023

(30) Foreign Application Priority Data
Feb. 12, 2021 (GB) 2101983.1

(51) Int. Cl. B01D 53/32; C25B 9/75

(52) U.S. Cl. CPC B01D 53/326; C25B 9/75; B01D 2256/16

(57) ABSTRACT

A multistage electrochemical hydrogen pump, comprising a first electrochemical hydrogen pumping stage fluidly connected to a second electrochemical hydrogen pumping stage. The first electrochemical pumping stage is configured to receive a first gas mixture comprising hydrogen gas, electrochemically separate hydrogen gas from the first gas mixture to produce a second gas mixture, and output the second gas mixture to the second electrochemical pumping stage. The second electrochemical hydrogen pumping stage is configured to receive the second gas mixture from the first electrochemical hydrogen pumping stage, electrochemically separate hydrogen gas from the second gas mixture to produce a third gas mixture, and output the third gas mixture.

### CROSS-REFERENCE TO RELATED APPLICATION

This application is a Section 371 National Stage Application of International Application No. PCT/162022/050814 filed Jan. 31, 2022, and published as WO 2022/172120 A1 on Aug. 18, 2022, the content of which is hereby incorporated by reference in its entirety and which claims priority of British Application No. 2101983.1, filed Feb. 12, 2021.

### FIELD

The present invention relates to electrochemical hydrogen pumps.

### BACKGROUND

Electrochemical hydrogen pumps are a known type of pump used in various different industries (e.g. metal wire annealing). Electrochemical hydrogen pumps typically work by separating hydrogen gas from a mixture of gases using one or more electrochemical cells.

FIG. 1 is a schematic illustration (not to scale) showing a conventional electrochemical hydrogen pump 100. The electrochemical hydrogen pump 100 comprises a housing 110, a plurality of electrochemical cells 120, a first current collector 130, a second current collector 140, input lines 150, and output lines 160.

The housing 110 defines a space in which the rest of the components of the electrochemical pump 100 are located. Specifically, the plurality of electrochemical cells 120, the first current collector 130, the second current collector 140, the input lines 150, and the output lines 160 are located in the space defined by the housing 110.

The plurality of electrochemical cells 120 are each configured to receive a first gas mixture comprising hydrogen gas, electrochemically separate hydrogen gas from the first gas mixture, and output a second gas mixture comprising the separated hydrogen gas. The plurality of electrochemical cells 120 are arranged in a stack and fluidly connected in parallel with each other. Each of the plurality of electrochemical cells 120 comprises an anode chamber 122, a cathode chamber 124, and an ion exchange mechanism 126. Each anode chamber 122 comprises an anode and is configured to receive the first gas mixture from the input lines 150. Each cathode chamber 124 comprises a cathode and is configured to output the second gas mixture into the output lines 160. Each ion exchange mechanism 126 is located between the respective anode and cathode chambers 122, 124 and separates the respective anode and cathode chambers 122, 124 from each other such that the ion exchange mechanism 126 acts as a partial barrier to fluid flow between the respective anode and cathode chambers 122, 124. The ion exchange mechanism 126 of each electrochemical cell 120 is semi-permeable in that it is configured to selectively permit hydrogen ions to pass therethrough to migrate from the respective anode chamber 122 to the respective cathode chamber 124, whilst substantially preventing the other components of the first gas mixture from passing therethrough.

The first gas mixture is made up of hydrogen gas mixed with one or more other types of gas. The second gas mixture is the result of the electrochemical hydrogen separation performed by the electrochemical cells 120 and so has a much higher proportion of hydrogen gas compared to the first gas mixture. Specifically, the second gas mixture is made up of almost exclusively hydrogen gas, but still contains a small trace amount of the one or more other types of gas (which can be referred to as impurities or contaminates) which have managed to migrate across the ion exchange mechanisms 126, e.g. due to imperfections in the ion exchange mechanisms 126.

The anodes may be made of a catalyst material comprising platinum nanoparticles which may or may not be supported on carbon microparticles. The cathodes may also be made of a catalyst material comprising platinum nanoparticles which may or may not be supported on carbon microparticles. The ion exchange mechanisms 126 may be made of ion exchange mechanism materials such as, but not limited to, Nafion or Polybenzimidazole (PBI). However, it will be appreciated that any appropriate material or combination of materials may be used as long as said components are able to function in the manner described herein.

The first and second current collectors 130, 140 electrically connect the anodes and cathodes of the plurality of electrochemical cells 120 to an electrical power source (not shown) to maintain the positive voltage potential of the anodes and the negative voltage potential of the cathodes.

The input lines 150 are configured to receive the first gas mixture from a source (not shown) remote from the electrochemical hydrogen pump 100 and to convey the first gas mixture into the anode chambers 122 of the plurality of electrochemical cells 120.

The output lines 160 are configured to receive the second gas mixture from the cathode chambers 124 of the plurality of electrochemical cells 120 and to convey the second gas mixture to a desired location (not shown) remote from the electrochemical hydrogen pump 100.

The precise physical/chemical mechanisms behind the operation of the electrochemical cells 120 are well known and will not be described in detail herein for the sake of brevity. However, briefly, during operation of the electrochemical hydrogen pump 100, the hydrogen gas in the first gas mixture is oxidised at the anodes in the anode chambers 122 to produce hydrogen ions. Then, the hydrogen ions pass through the ion exchange mechanisms 126 into the cathode chambers 124 and undergo a reduction reaction at the cathodes to reform into hydrogen gas. Since the ion exchange mechanisms 126 selectively permit hydrogen ions to pass therethrough whilst substantially preventing the other components of the first gas mixture from passing therethrough, the concentration of hydrogen gas in the second gas mixture is increased compared to the concentration of hydrogen gas in the first gas mixture. Hence, hydrogen gas is effectively selectively pumped (or separated) out of the first gas mixture by the electrochemical cells 220.

FIG. 2 is a schematic illustration (not to scale) showing a cross-sectional view of the ion exchange mechanism 126 in more detail. The ion exchange mechanism forms part of a membrane electrode assembly (MEA) which comprises the anode, the cathode, an ion exchange membrane 126a, an anode catalyst layer 126b, a cathode catalyst layer 126c, an anode gas diffusion layer 126d and a cathode gas diffusion layer 126e. In some embodiments, the anode catalyst layer 126b is the anode of the MEA. In some embodiments, the cathode catalyst layer 126c is the cathode of the MEA. The ion exchange membrane 126a is sandwiched between the anode catalyst layer 126b and the cathode catalyst layer 126c. The anode catalyst layer 126b is sandwiched between the ion exchange membrane 126a and the anode gas diffusion layer 126d. The cathode catalyst layer 126c is sandwiched between the ion exchange membrane 126a and the anode gas diffusion layer 126e. In other words, the ion exchange membrane 126a, anode catalyst layer 126b, cathode catalyst layer 126c, anode gas diffusion layer 126d and a cathode gas diffusion layer 126e form a layered stack which acts as an ion exchange mechanism. The precise way in which MEAs function is well known and will not be described in any further detail herein for the sake of brevity. It is desirable to improve upon the conventional electrochemical hydrogen pump 100 described above.

The discussion above is merely provided for general background information and is not intended to be used as an aid in determining the scope of the claimed subject matter. The claimed subject matter is not limited to implementations that solve any or all disadvantages noted in the background.

### SUMMARY

In a first aspect, there is provided a multistage electrochemical hydrogen pump, comprising a first electrochemical hydrogen pumping stage fluidly connected to a second electrochemical hydrogen pumping stage. The first electrochemical pumping stage is configured to receive a first gas mixture comprising hydrogen gas, electrochemically separate hydrogen gas from the first gas mixture to produce a second gas mixture, and output the second gas mixture to the second electrochemical pumping stage. The second electrochemical hydrogen pumping stage is configured to receive the second gas mixture from the first electrochemical hydrogen pumping stage, electrochemically separate hydrogen gas from the second gas mixture to produce a third gas mixture, and output the third gas mixture.

One or both of the first and second electrochemical hydrogen pumping stages may comprise a plurality of electrochemical cells fluidly connected in parallel with each other.

The plurality of electrochemical cells of one or both of the first and second electrochemical hydrogen pumping stages may be arranged as a stack.

Each of the first and second electrochemical hydrogen pumping stages may comprise a plurality of electrochemical cells fluidly connected in parallel with each other.

An output of each of the plurality of electrochemical cells of the first electrochemical hydrogen pumping stage may be fluidly connected to an input of each of the plurality of electrochemical cells of the second electrochemical hydrogen pumping stage.

The first and second electrochemical hydrogen pumping stages may be fluidly connected to each other via fluid lines or via a channel defined by bipolar plates.

The multistage electrochemical hydrogen pump may further comprise a housing, wherein the first and second electrochemical hydrogen pumping stages are located within the housing.

The second gas mixture may have a greater proportion of hydrogen gas compared to the first gas mixture, and the third gas mixture has a greater proportion of hydrogen gas compared to the second gas mixture.

The first gas mixture may be made up of hydrogen gas and one or more other types of gas, wherein the one or more other types of gas are selected from the group consisting of: nitrogen gas, carbon dioxide gas, helium gas, argon gas, carbon monoxide gas.

The hydrogen gas may comprise one or more of: protium, deuterium and tritium.

The multistage electrochemical hydrogen pump may further comprise one or more further electrochemical hydrogen pumping stages fluidly connected in series to the first and second electrochemical hydrogen pumping stages.

In a second aspect, there is provided a vacuum pumping system comprising the multistage electrochemical hydrogen pump of the first aspect.

The multistage electrochemical hydrogen pump may be fluidly connected to a vacuum pump and configured to receive the first gas mixture from the vacuum pump.

In a third aspect, there is provided an extreme ultraviolet lithography system comprising the vacuum pumping system of the second aspect.

The first gas mixture may be made up of hydrogen gas and nitrogen gas.

In a fourth aspect, there is provided the use of the multistage electrochemical hydrogen pump of the first aspect.

The summary is provided to introduce a selection of concepts in a simplified form that are further described in the detailed description. This summary is not intended to identify key features or essential features of the claimed subject matter, nor is it intended to be used as an aid in determining the scope of the claimed subject matter.

### BRIEF DESCRIPTION OF DRAWINGS

FIG. 1 is a schematic illustration (not to scale) showing a conventional electrochemical hydrogen pump;

FIG. 2 is a schematic illustration (not to scale) showing a cross-sectional view of an ion exchange mechanism of the conventional electrochemical hydrogen pump;

FIG. 3 is a schematic illustration (not to scale) showing a multistage electrochemical hydrogen pump; and

FIG. 4 is a schematic illustration (not to scale) showing another multistage electrochemical hydrogen pump.

### DETAILED DESCRIPTION

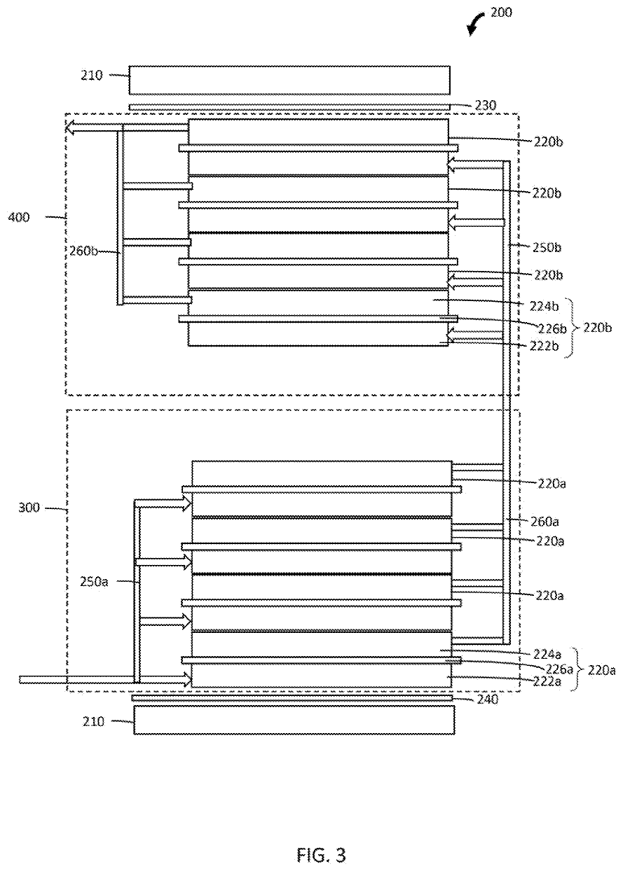

FIG. 3 is a schematic illustration (not to scale) showing a multistage stage electrochemical hydrogen pump 200 according to an embodiment.

The electrochemical hydrogen pump 200 comprises a housing 210, a first electrochemical hydrogen pumping stage 300, a second electrochemical hydrogen pumping stage 400, a first current collector 230, and a second current collector 240.

The housing 210 defines a space in which the rest of the components of the electrochemical pump 200 are located. Specifically, the first electrochemical hydrogen pumping stage 300, the second electrochemical hydrogen pumping stage 400, the first current collector 230, and the second current collector 240 are located in the space defined by the housing 110.

The first electrochemical hydrogen pumping stage 300 comprises a plurality of first electrochemical cells 220a, first input lines 250a and first output lines 260a.

The plurality of first electrochemical cells 220a are each configured to receive a first gas mixture comprising hydrogen gas, electrochemically separate hydrogen gas from the first gas mixture, and output a second gas mixture comprising the separated hydrogen gas.

The hydrogen gas in the first and second gas mixtures may comprise any one of or any combination of the different isotopes of hydrogen (i.e. protium, deuterium, tritium).

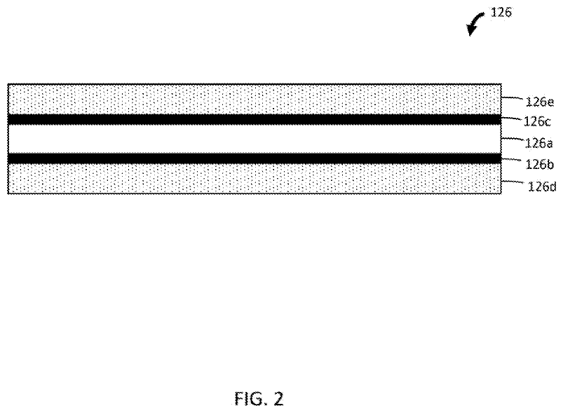

The plurality of first electrochemical cells 220a are arranged in a stack and fluidly connected in parallel with each other. Each of the plurality of first electrochemical cells 220a comprises a first anode chamber 222a, a first cathode chamber 224a, and a first ion exchange mechanism 226a. Each first anode chamber 222a comprises an anode and is configured to receive the first gas mixture from the first input lines 250a. Each first cathode chamber 224a comprises a cathode and is configured to output the second gas mixture into the first output lines 260a. Each first ion exchange mechanism 226a is located between the respective first anode and cathode chambers 222a, 224a and separates the respective first anode and cathode chambers 222a, 224a from each other such that the first ion exchange mechanism 226a acts as a partial barrier to fluid flow between the respective first anode and cathode chambers 222a, 224a. The first ion exchange mechanism 226a of each first electrochemical cell 220a is semi-permeable in that it is configured to selectively permit hydrogen ions to pass therethrough to migrate from the respective first anode chamber 222a to the respective first cathode chamber 224a, whilst substantially preventing the other components of the first gas mixture from passing therethrough. Each first ion exchange mechanism 226a has the same structure as the ion exchange mechanism 126 described above with reference to FIG. 2.

The first gas mixture is made up of hydrogen gas mixed with one or more other types of gas (e.g. nitrogen, carbon dioxide, helium, argon, carbon monoxide). For example, the first gas mixture may be 50% hydrogen gas and 50% of the one or more other types of gas. The second gas mixture is the result of the electrochemical hydrogen separation performed by the first electrochemical cells 220a and so has a much higher proportion of hydrogen gas compared to the first gas mixture. Specifically, the second gas mixture is made up of almost exclusively hydrogen gas, but still contains a trace amount of the one or more other types of gas which has managed to migrate across the first ion exchange mechanisms 226, e.g. due to imperfections in the selective permeability of the first ion exchange mechanisms 226. For example, the second gas mixture may have approximately 100 parts per million of the one or more other types of gas (i.e. impurities or contaminates) and the rest being hydrogen gas.

The first input lines 250a are configured to receive the first gas mixture from a source (not shown) remote from the electrochemical hydrogen pump 200 and to convey the first gas mixture into the first anode chambers 222a of the plurality of first electrochemical cells 220a. The first input lines 250a are fluid lines, e.g. pipes or tubes made from any appropriate material.

The first output lines 260a are configured to receive the second gas mixture from the first cathode chambers 224a of the plurality of first electrochemical cells 220a and to convey the second gas mixture to the second electrochemical hydrogen pumping stage 400. The first output lines 260a are fluid lines, e.g. pipes or tubes made from any appropriate material.

The second electrochemical hydrogen pumping stage 400 comprises a plurality of second electrochemical cells 220b, second input lines 250b and second output lines 260b.

The plurality of second electrochemical cells 220b are each configured to receive the second gas mixture, electrochemically separate hydrogen gas from the second gas mixture, and output a third gas mixture comprising the separated hydrogen gas. The plurality of second electrochemical cells 220b are arranged in a stack and fluidly connected in parallel with each other. Each of the plurality of second electrochemical cells 220b comprises a second anode chamber 222b, a second cathode chamber 224b, and a second ion exchange mechanism 226b. Each second anode chamber 222b comprises an anode and is configured to receive the second gas mixture from the second input lines 250b. Each second cathode chamber 224b comprises a cathode and is configured to output the third gas mixture into the second output lines 260b. Each second ion exchange mechanism 226b is located between the respective second anode and cathode chambers 222b, 224b and separates the respective second anode and cathode chambers 222b, 224b from each other such that the second ion exchange mechanism 226b acts as a partial barrier to fluid flow between the respective second anode and cathode chambers 222b, 224b. The second ion exchange mechanism 226b of each second electrochemical cell 220b is semi-permeable in that it is configured to selectively permit hydrogen ions to pass therethrough to migrate from the respective second anode chamber 222b to the respective second cathode chamber 224b, whilst substantially preventing the other components of the second gas mixture from passing therethrough. Each second ion exchange mechanism 226b has the same structure as the ion exchange mechanism 126 described above with reference to FIG. 2.

The third gas mixture is the result of a further stage of electrochemical hydrogen separation performed by the second electrochemical cells 220b and so has an even higher proportion of hydrogen gas compared to the second gas mixture. In other words, the third gas mixture has an even lower proportion gases which are not hydrogen gas than the second gas mixture. For example, the third gas mixture may have approximately 40 parts per billion of impurities or contaminates, and the rest being hydrogen gas.

The second input lines 250b are fluidly connected to the first output lines 260a. The second input lines 250b are configured to receive the second gas mixture from the first output lines 160a of the first electrochemical hydrogen pumping stage 300 and to convey the second gas mixture into the second anode chambers 222b of the plurality of second electrochemical cells 220b. The second input lines 250b are fluid lines, e.g. pipes or tubes made from any appropriate material.

The second output lines 260b are configured to receive the third gas mixture from the second cathode chambers 224b of the plurality of second electrochemical cells 220b and to convey the third gas mixture to a desired location (not shown) remote from the electrochemical hydrogen pump 200. The second output lines 260b are fluid lines, e.g. pipes or tubes made from any appropriate material.

The first and second current collectors 230, 240 electrically connect the anodes and cathodes of the first and second electrochemical cells 220a, 220b to an electrical power source (not shown) to maintain the positive charge of the anodes and the negative charge of the cathodes.

The precise physical/chemical mechanisms behind the operation of the first and second electrochemical cells 220a, 220b are well known and will not be described in detail herein for the sake of brevity. However, briefly, during operation of the electrochemical hydrogen pump 200, the hydrogen gas in the first gas mixture is oxidised at the anodes in the first and second anode chambers 222a, 222b to produce hydrogen ions. Then, the hydrogen ions pass through the first and second ion exchange mechanisms 226a, 226b into the first and second cathode chambers 224a, 224b and undergo a reduction reaction at the cathodes to reform into hydrogen gas. Since the first and second ion exchange mechanisms 226a, 226b selectively permit hydrogen ions to pass therethrough whilst substantially preventing the other components of the first and second gas mixtures from passing therethrough, the concentration of hydrogen gas in the second gas mixture is increased compared to the concentration of hydrogen gas in the first gas mixture, and the concentration of hydrogen gas in the third gas mixture is increased compared to the concentration of hydrogen gas in the second gas mixture. Hence, hydrogen gas is effectively selectively pumped (or separated) out of the first and second gas mixtures by the first and second electrochemical cells 220a, 220b respectively.

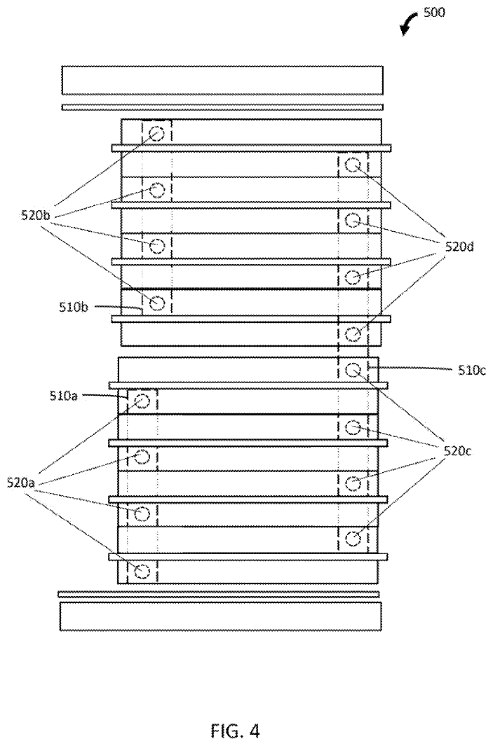

FIG. 4 is a schematic illustration (not to scale) showing a multistage electrochemical hydrogen pump 500 according to another embodiment. The embodiment of FIG. 4 is the same as the embodiment of FIG. 3, except that rather than using fluid lines, the anode chambers and cathode chambers are fluidly connected via channels and holes defined by (or machined into) bipolar plates (not shown) which sandwich each electrochemical cell. In this embodiment, each electrochemical cell is sandwiched between a respective pair of bipolar plates, and the anode and cathode chambers of each electrochemical cell are each defined between a respective one of the pair of bipolar plates and the ion exchange mechanism of that electrochemical cell.

More specifically, the first anode chambers of the first electrochemical hydrogen pumping stage are fluidly connected to each other via a first channel 510a extending through the bipolar plates and respective first holes 520a in the bipolar plates. The first anode chambers are configured to receive the first gas mixture, via the first channel 510a and the first holes 520a, from a source remote from the electrochemical hydrogen pump 500.

The second cathode chambers of the second electrochemical hydrogen pumping stage are fluidly connected to each other via a second channel 510b extending through the bipolar plates and respective second holes 520b in the bipolar plates. The second cathode chambers are configured to output the third gas mixture, via the second holes 520b and the second channel 510b out of the electrochemical hydrogen pump 500.

The first cathode chambers of the first electrochemical hydrogen pumping stage are fluidly connected to each other via a third channel 510c extending through the bipolar plates and respective third holes 520c in the bipolar plates. The first cathode chambers are configured to output the second gas mixture into the third channel 510c via the third holes 520c.

The second anode chambers of the second electrochemical hydrogen pumping stage are fluidly connected to each other via the third channel 510c and respective fourth holes 520d. The second anode chambers are configured to receive the second gas mixture from the third channel 510c via the fourth holes 520d.

The first cathode chambers of the first electrochemical hydrogen pumping stage and the second anode chambers of the second electrochemical hydrogen stage are fluidly connected to each other via the third channel 510c. The third channel 510c is configured to convey the second gas mixture from the first cathode chambers of the first electrochemical hydrogen pumping stage to the second anode chambers of the second electrochemical hydrogen pumping stage. Thus, advantageously, the embodiment of FIG. 4 tends to make use of a way of fluidly connecting the two electrochemical hydrogen pumping stages which is relatively compact and obviates the use of fluid lines such as pipes to perform said function.

Thus, a multistage electrochemical hydrogen pump is provided.

The above-described multistage electrochemical hydrogen pump may be used to provide hydrogen gas in any appropriate system which requires it. For example, the above-described multistage electrochemical hydrogen pump may be used as part of an extreme ultraviolet (EUV) lithography system. Specifically, the multistage electrochemical hydrogen pump may be part of a vacuum pumping system of an EUV lithography system and be configured to receive the first gas mixture from a vacuum pump and to output the third gas mixture to a location in the EUV lithography system where it is required. An example of such a location is at the input of the EUV lithography tool, as part of a semi-closed loop hydrogen recycling process. The EUV tool requires significant hydrogen input, which is eventually exhausted (with impurities) through the vacuum pumping system. By removing the impurities and pressuring the hydrogen through a multistage electrochemical pump, hydrogen that would normally be discarded as contaminated waste may be recycled back into the EUV lithography tool. In EUV lithography systems, the first gas mixture may be made up of hydrogen gas and nitrogen gas.

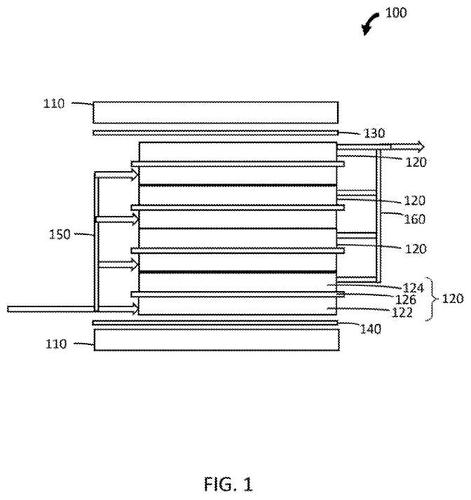

Advantageously, the above-described multistage electrochemical hydrogen pump tends to output a final gas mixture with a higher proportion of hydrogen gas compared to conventional single stage electrochemical hydrogen pumps such as the one illustrated by FIG. 1. In other words, the final gas mixture output by the above-described multistage electrochemical hydrogen pump (i.e. the third gas mixture) tends to have a lower amount of gases which are not hydrogen (i.e. contaminates or impurities). For example, testing has found that the output of a multistage electrochemical hydrogen pumps such as the ones described above with reference to FIGS. 3 and 4 tend to have of the order of 40 parts per billion of impurities, whereas the output of single stage electrochemical hydrogen pumps such as the one described above with reference to FIG. 1 tends to have 100 parts per million of impurities (i.e. approximately 2500 times more than the output of the multistage ones). Thus, the above-described multistage electrochemical hydrogen pump tends to have a much higher purity output than conventional single stage electrochemical hydrogen pumps. As such, use of multistage electrochemical pumps tends to be particularly beneficial for use in systems where very high purity hydrogen gas is required, e.g. in extreme ultraviolet (EUV) lithography systems.

In the above embodiments, the multistage electrochemical hydrogen pump has only two electrochemical hydrogen pumping stages connected in series. However, in other embodiments, more than two electrochemical hydrogen pumping stages connected in series are used to further reduce the proportion of impurities or contaminates in the gas output by the multistage electrochemical hydrogen pump.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A multistage electrochemical hydrogen pump, comprising:
a first electrochemical hydrogen pumping stage fluidly connected to a second electrochemical hydrogen pumping stage,
wherein the first electrochemical pumping stage is configured to receive a first gas mixture comprising hydrogen gas, electrochemically separate hydrogen gas from the first gas mixture to produce a second gas mixture, and output the second gas mixture to the second electrochemical pumping stage, and
wherein the second electrochemical hydrogen pumping stage is configured to receive the second gas mixture from the first electrochemical hydrogen pumping stage, electrochemically separate hydrogen gas from the second gas mixture to produce a third gas mixture, and output the third gas mixture.

2. The multistage electrochemical hydrogen pump of claim 1, wherein one or both of the first and second electrochemical hydrogen pumping stages comprise a plurality of electrochemical cells fluidly connected in parallel with each other.

3. The multistage electrochemical hydrogen pump of claim 2, wherein the plurality of electrochemical cells of one or both of the first and second electrochemical hydrogen pumping stages are arranged as a stack.

4. The multistage electrochemical hydrogen pump of claim 2, wherein each of the first and second electrochemical hydrogen pumping stages comprises a plurality of electrochemical cells fluidly connected in parallel with each other, and wherein an output of each of the plurality of electrochemical cells of the first electrochemical hydrogen pumping stage is fluidly connected to an input of each of the plurality of electrochemical cells of the second electrochemical hydrogen pumping stage.

5. The multistage electrochemical hydrogen pump of claim 1, wherein the first and second electrochemical hydrogen pumping stages are fluidly connected to each other via fluid lines or via a channel defined by bipolar plates.

6. The multistage electrochemical hydrogen pump of claim 1, further comprising a housing, wherein the first and second electrochemical hydrogen pumping stages are located within the housing.

7. The multistage electrochemical hydrogen pump of claim 1, wherein the second gas mixture has a greater proportion of hydrogen gas compared to the first gas mixture, and the third gas mixture has a greater proportion of hydrogen gas compared to the second gas mixture.

8. The multistage electrochemical hydrogen pump of claim 1, wherein the first gas mixture is made up of hydrogen gas and one or more other types of gas, wherein the one or more other types of gas are selected from the group consisting of: nitrogen gas, carbon dioxide gas, helium gas, argon gas, carbon monoxide gas.

9. The multistage electrochemical hydrogen pump of claim 1, wherein the hydrogen gas comprises one or more of: protium, deuterium and tritium.

10. The multistage electrochemical hydrogen pump of claim 1, further comprising one or more further electrochemical hydrogen pumping stages fluidly connected in series to the first and second electrochemical hydrogen pumping stages.

11. A vacuum pumping system comprising the multistage electrochemical hydrogen pump of claim 1.

12. The vacuum pumping system of claim 11, wherein the multistage electrochemical hydrogen pump is fluidly connected to a vacuum pump and configured to receive the first gas mixture from the vacuum pump.

13. An extreme ultraviolet lithography system comprising the vacuum pumping system of claim 11.

14. The extreme ultraviolet lithography system of claim 13, wherein the first gas mixture is made up of hydrogen gas and nitrogen gas.

15. Use of the multistage electrochemical hydrogen pump of claim 1 to pump hydrogen gas.
